(19) United States
(12) Patent Application Publication
(10) Pub. No.: US 2011/0094998 A1
(43) Pub. Date: Apr. 28, 2011

(54) ELECTRODE WIRE FOR ELECTRIC DISCHARGING WORKING

(76) Inventor: Kuo-Ta Chang, Taipei (TW)

(21) Appl. No.: 12/605,378

(22) Filed: Oct. 26, 2009

(51) Int. Cl. B23H 1/06

(52) U.S. Cl. 219/69.15

(57) ABSTRACT

An electrode wire for discharging working; the electrode wire being formed by an alloy of copper and zinc; in manufacturing process, passing the alloy with a form of fluid through a furnace so as to form with a desire shape; wherein by siphon theory, a metal tube serves to suck the alloy; the process is made continuously in a predetermined temperature; then the alloy being performed with cold-extension and annealing repeatedly so as to form with electrode wire which is stable, uniform and has a preferred electric conductivity. in the alloy of copper and zinc, the content of zinc is about 35˜45%. An extension strength of the wire is between 650 to 1150 MPa.

### FIELD OF THE INVENTION

The present invention relates to electrode wire for electric discharging working, and particularly to an electrode wire which can discharge electrically between the wire and a cut object so that the cut object can be melt quickly. Comparing with current used electrode wires, the yield ratio of the present invention is high.

### BACKGROUND OF THE INVENTION

The process of line discharging working is to discharge between an electrode wire for discharging between the wire and a cut object and then melt the object. Because this method can be used in a saw path cutting work so that it is especially suitable for an object with complicated outline. However it has a demand for an electrode wire which can reduce the discharging cost.

With referring to FIG. 1, the process for manufacturing electrode wire is illustrated. Firstly, copper and zinc are mixed to be formed as an alloy. Then it is cut into several sections to be heated. Then they are heated and rolled to be as round bars. In the process, the temperature is descent from about 700° C. to about 580° C. so that the crystals 10 in the bars are not stable and not uniform. Referring to FIG. 2, in the manufacturing process of the wires, it is easy to generate air holes, and crystal phases are not stable. In the process, the air holes will induce the bar to break, while the labor must to check the material. This is time and labor wasted. The unstableness of the crystal phase will affect the tension strength and the electric conductivity is not stable. In fine-discharging process, the machining process can not be controlled precisely. Thereby there is a demand for a novel electrode for line-discharging machining so as to resolve above mentioned problem.

### SUMMARY OF THE INVENTION

The object of the present invention is to provide an electrode wire for line-discharging working. In the copper-zinc alloy, the content of the zinc is about 35˜45%. The processes of cold-extension and annealing are performed repeated so as to control the crystal process of the electrode wire.

To achieve object, the present invention provides an electrode wire for discharging working. The method for manufacturing an electrode wire for discharging working comprises the steps of: dissolving and mixing copper and zinc, wherein the content of zinc is about 40%; passing the dissolving fluid passes through a furnace 1 in a temperature about 955° C. so as to form with a desire shape; wherein by siphon theory, a metal tube serves to suck the alloy. The process is made continuously in a predetermined temperature. Then the alloy is performed with cold-extension and annealing repeatedly so as to form with alloy lines with a diameter from 0.25 mm to 0.3 mm.

Next, the final electric annealing process is performed.

The crystal structure 5, the distribution, extension, manufacturing process of the present invention are illustrated. It is illustrated that the present invention has preferred conductivity.

The various objects and advantages of the present invention will be more readily understood from the following detailed description when read in conjunction with the appended drawing.

### BRIEF DESCRIPTION OF THE DRAWINGS

FIG. 1 is a schematic view showing the manufacturing process of the present invention.

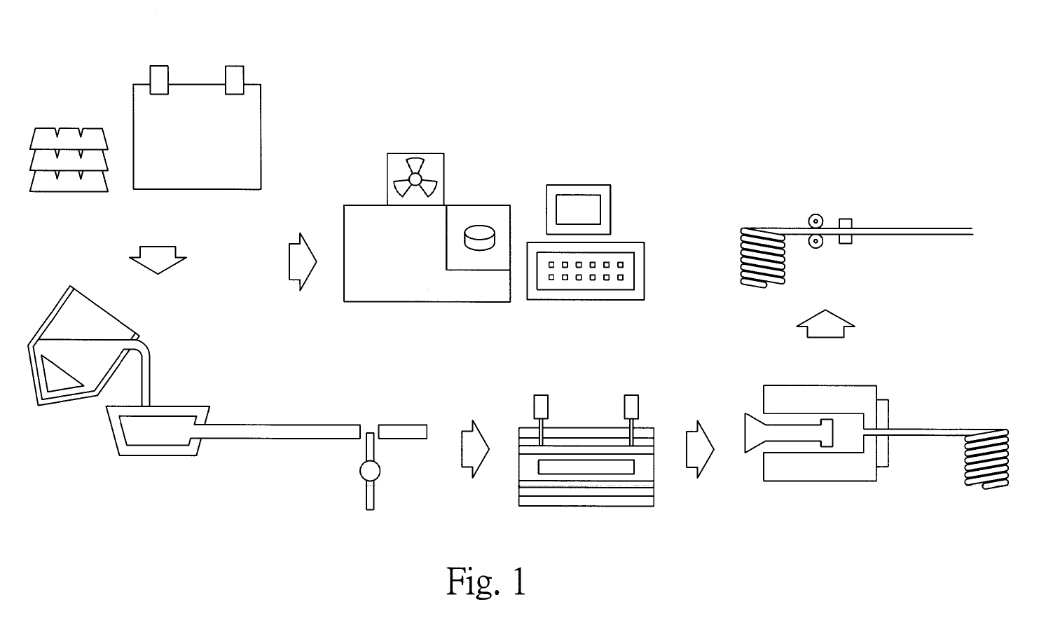

FIG. 2 is a schematic view showing the crystal structure of the electrode wire according to the present invention.

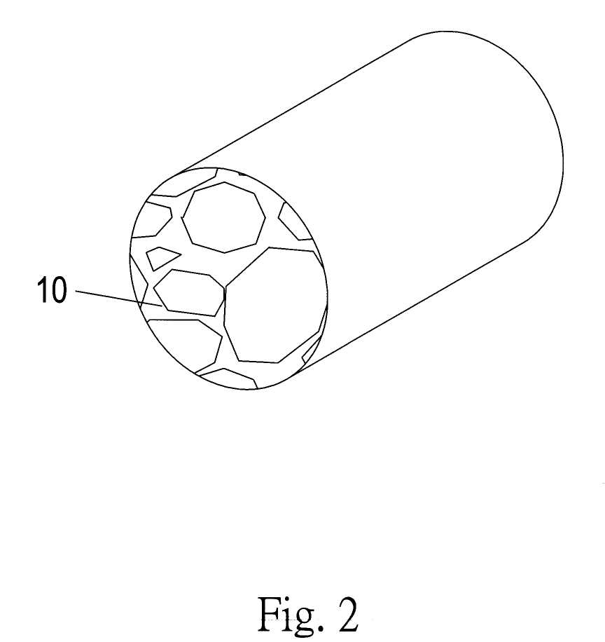

FIG. 3 is a schematic view showing the manufacturing process of the present invention.

FIG. 4 is a schematic view showing the crystal structure of the electrode wire of the present invention.

FIG. 5 is a schematic cross sectional view showing the crystal structure of the electrode wire of the present invention.

FIG. 6 is a table showing the pulling force test table of the present invention.

### DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

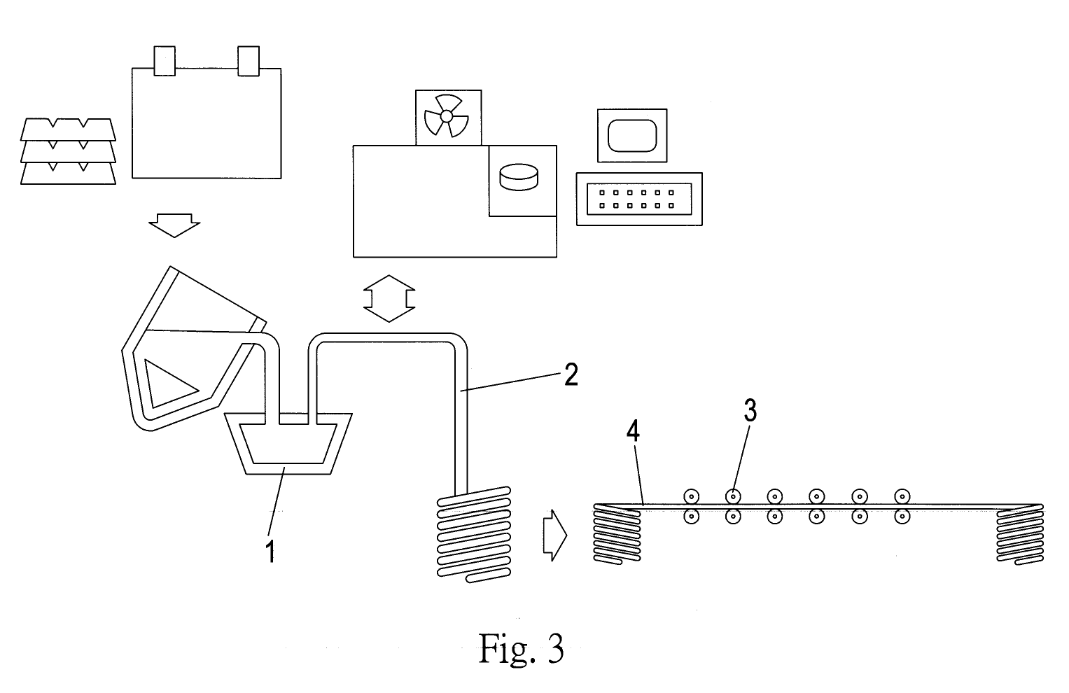

Referring to FIG. 3, an electrode wire for discharging working is illustrated. The electrode wire is formed by an alloy of copper and zinc. The method for manufacturing an electrode wire for discharging working comprises the steps of: dissolving and mixing copper and zinc, wherein the content of zinc is about 40%; passing the dissolving fluid through a furnace 1 in a temperature about 955° C. so as to form with a desire shape; wherein by siphon theory, a metal tube serves to suck the alloy. The process is made continuously in a predetermined temperature. Then the alloy is performed with cold-extension and annealing repeatedly so as to form with alloy wires with a diameter from 0.25 mm to 0.3 mm.

Next, the final electric annealing process is performed.

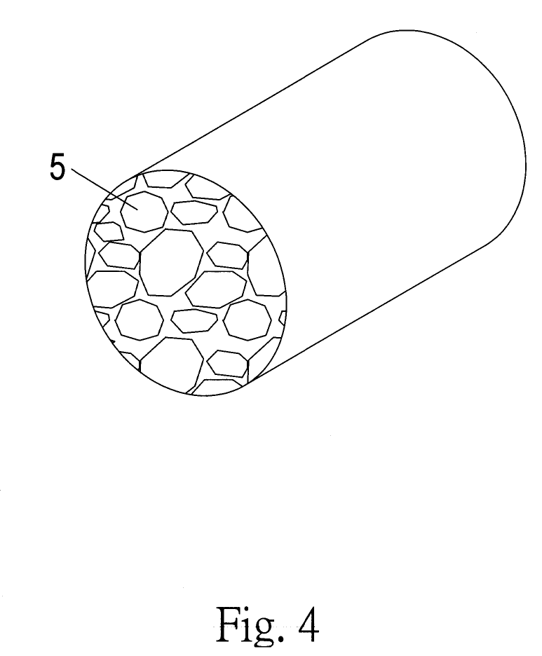

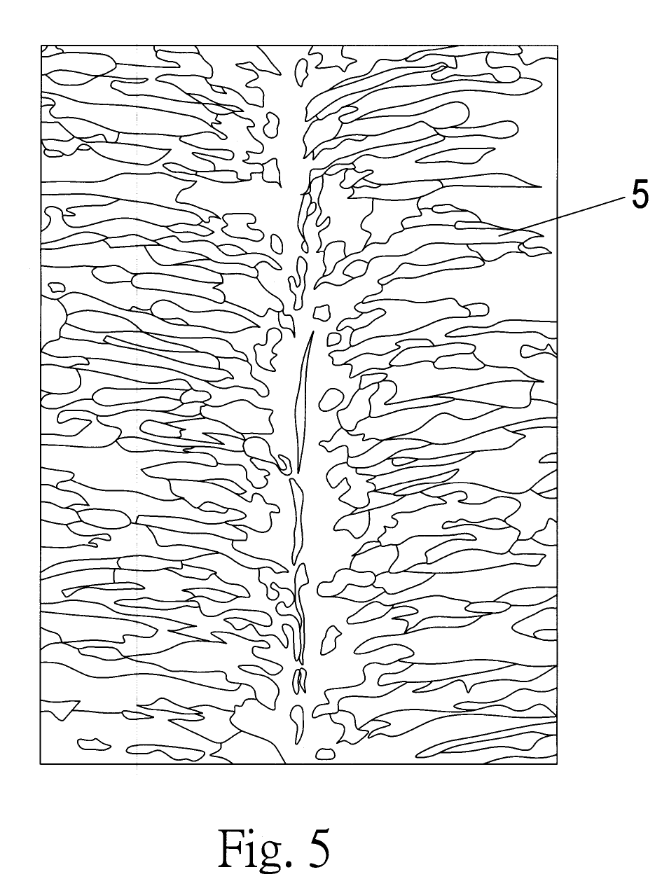

Referring to FIGS. 4 and 5, the crystal structure 5, the distribution, extension, manufacturing process of the present invention are illustrated. It is illustrated that the present invention has preferred conductivity.

The resistance test for the electrode wire of the present invention is illustrated in the following.

| Cases | Resistance (Ω) | Conductivity (%) |
|---|---|---|
| 1 | 1.6924 | 21.6695 |
| 2 | 1.6730 | 21.9208 |
| 3 | 1.6994 | 21.5803 |
| 4 | 1.7083 | 21.5006 |
| 5 | 1.7057 | 21.3379 |
| 6 | 1.7187 | 21.3169 |
| 7 | 1.7204 | 21.3292 |
| 8 | 1.7194 | 21.2822 |
| 9 | 1.7232 | 21.3193 |
| 10 | 1.7202 | 21.4725 |
| Average | 1.7081 | 21.4725 |
| Standard difference | 0.0161 | 0.1936 |

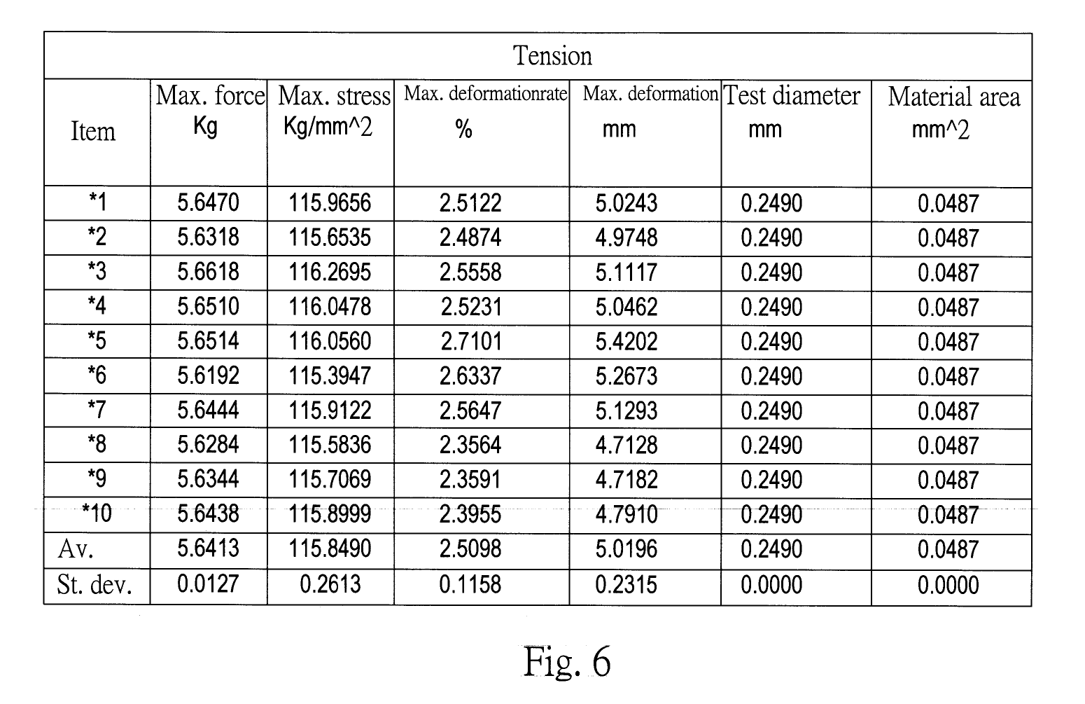

With referring to FIG. 6, it is illustrated that an extension working is performed to the electrode wire for discharging working according to the present invention. The final diameter φ of the wire is 1.2 mm with a pulling force of 500˜650 MPa and pulling range of 80. The cold pulling and annealing process are performed step by step. The final wire diameter of the final produce has a pulling strength of 650˜1150 MPa.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An electrode wire for discharging working; the electrode wire being an alloy of copper and zinc; in manufacturing process, passing the alloy with a form of fluid through a furnace so as to form with a desire shape; wherein by siphon theory, a metal tube serves to suck the alloy; the process is made continuously in a predetermined temperature; then the alloy being performed with cold-extension and annealing repeatedly so as to form with electrode wire which is stable, uniform and has a preferred electric conductivity.

2. The electrode wire as claimed in claim 1, wherein in the alloy of copper and zinc, a content of zinc is about 35˜45%.

3. The electrode wire as claimed in claim 1, wherein an extension strength of the wire is between 650 to 1150 MPa.

4. The electrode wire as claimed in claim 2, wherein an extension strength of the wire is between 650 to 1150 MPa.
